(19) United States
(12) Patent Application Publication
(10) Pub. No.: US 2013/0006936 A1
(43) Pub. Date: Jan. 3, 2013

(54) CAPTURING AN ARCHIVING SNAPSHOT

(76) Inventor: Lily Ya Liu Chen, Cupertino, CA (US)

(21) Appl. No.: 13/173,862

(22) Filed: Jun. 30, 2011

(51) Int. Cl. G06F 7/00

(52) U.S. Cl. 707/639; 707/E17.044

(57) ABSTRACT

A technique includes, in a first computer system, archiving data for a plurality of environments. Each of the environments are associated with a different combination of an active data source selected from a plurality of active data sources and an archive target selected from a plurality of archive targets. The technique includes capturing a partial snapshot of the archiving, the partial snapshot is associated with one environment for the plurality of environments such that the partial snapshot may be used to replicate said archiving associated with the one environment on another computer system.

### BACKGROUND

Data stored in a database may be archived for such purposes as long term data retention and reducing the footprint of an active database. The archiving may be controlled by predefined models and runtime policies. These models and policies may be developed and tested in a development environment until the implementation is stable. Thereafter, the implementation may be installed in a production system which may be run continuously and presumably handle a relatively large amount of data. It is conceivable that unexpected situations may arise in the production system, however, due to such factors as unforeseen data volumes or product limitations. It may be relatively challenging to address these issues in the production environment, without significantly impacting the environment.

### BRIEF DESCRIPTION OF THE DRAWING

FIG. 1 is a schematic diagram of a production system and a test system according to example implementation.

FIGS. 2 and 4 are flow diagrams of techniques to capture and analyze partial snapshots of an archiving process in a computer system according to example implementations.

FIG. 3 depicts a first computer system to capture partial snapshots of an archiving process used in the first computer system and a second computer system to use the partial snapshot to evaluate the archiving process according to an exemplary implementation.

### DETAILED DESCRIPTION

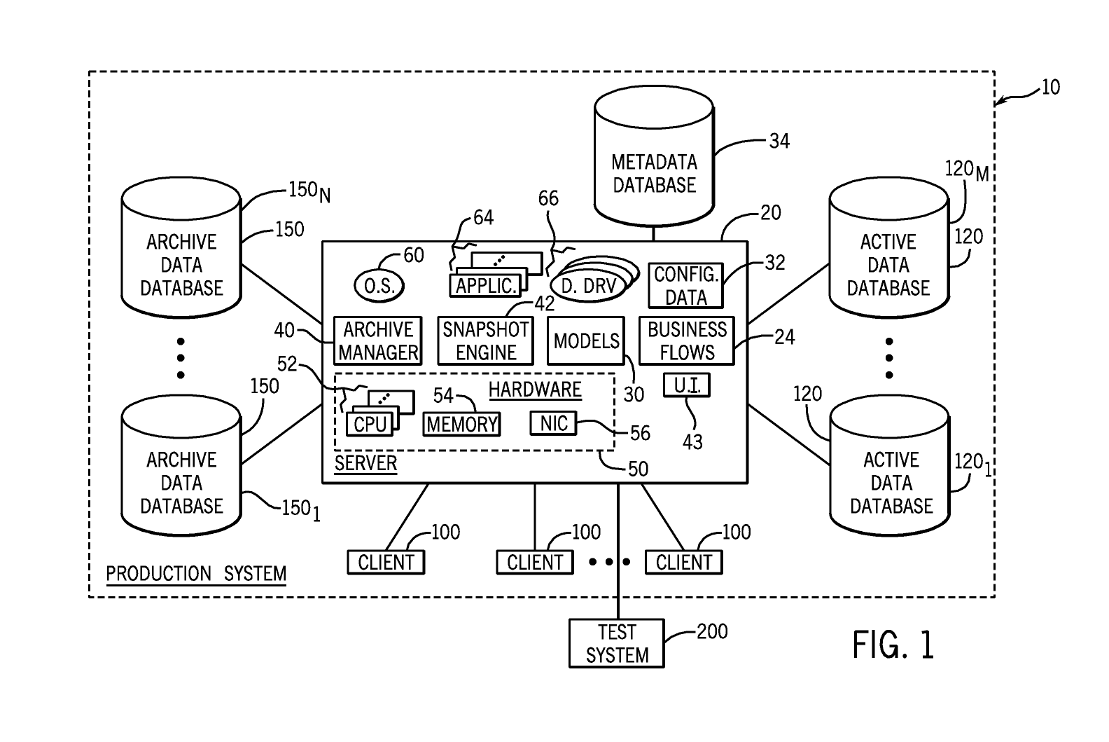

Referring to FIG. 1, a computer system, called a “production system 10,” herein contains a server 20, which executes machine executable instructions that form one or multiple applications 64, which cause the server 20 to store and retrieve active data from various active data databases (active data databases 120₁ . . . 120_{M}, being depicted in FIG. 1 as examples). In this manner, the application(s) may cause the server 20 to store and retrieve data from the active data databases 120 in response to corresponding requests from various clients 100. As a non-limiting example, the clients 100 may be data entry terminals, which are used for purposes of entering and processing sales orders for various products and/or services. The server 20 may process data other than data associated with sales orders, in accordance with many different possible implementations.

The active data stored in the active data databases 120 may be archived, for such purposes as long term data retention and reducing the footprint of the active data. For this purpose, the server 20 contains an archive manager 40, which selectively moves data between the active data databases 120 and archive data databases 150 (archive data databases 150₁ . . . 150_{N}, being depicted in FIG. 1 as non-limiting examples). To govern the archiving, the archive manager 40 relies on models, which define rules that govern the choice of data for inclusion in the archived data and business flows 24 that are a series of activities, such as archive operations and scripts, which run in a sequence for purposes of transitioning data between the active data databases 120 and the archive data databases 150.

In accordance with implementations disclosed herein, an instance of the archive manager 40 creates logical units, or partitions, called “archiving environments,” for purposes of separating data uses and metadata. In general, each archiving environment is uniquely associated with an active data source, such as one of the active data databases 120, and an archive target, such as one of the archive data databases 150. Archive jobs are executed within each archiving environment, and therefore, there is no interference among tasks from the different environments. Moreover, the instance of the archive manager 40 locates the databases and tables that are involved in specific runtime jobs. This design supports running parallel archive jobs to different data sources and targets and provides a way to partition runtime states, data, and jobs.

More specifically, in accordance with example implementations, each archiving environment contains the following. First, the archiving environment contains runtime metadata (stored in a metadata database 34), which describes how the active data is targeted for the archiving of data to the archive target. As non-limiting examples, the metadata may contain date ranges, time ranges and other criteria for purposes of selecting the particular active data to be archived. The archiving environment also includes configuration data 32, which specifies how the instance of the archive manager 40 is specifically configured. As non-limiting examples, this configuration information may indicate, for example, logging details, parameters for run time behavior, encryption used, etc. The archiving environment also includes the active runtime data, i.e., the data (from one or more active data databases 120) associated with the active data source.

It is conceivable that during a given archiving process established by the instance of the archive manager 40, unexpected issues may arise in the production system 10, due to such factors as unexpectedly large data volumes, unexpected application “bugs,” etc. For purposes of analyzing and safely correcting these issues without substantially interrupting operation of the production system 10, the server 10 contains a snapshot engine 42. The snapshot engine 42 is constructed to selectively acquire partial snapshots of the archiving process being employed by the instance of the archive manager 40. As described further below, the snapshot engine 42 takes these snapshots on customer selected portions (selected via a user interface 43) of the production system 10. Using these partial snapshots, a test environment may be generated on a test system 200 for purposes of replicating the production runtime states and configuration, as captured by the partial snapshots.

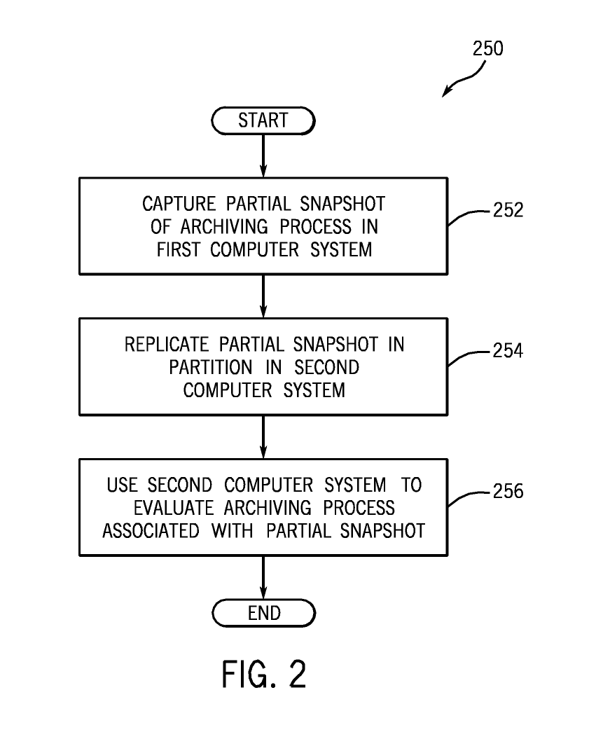

More specifically, referring to FIG. 2 in conjunction with FIG. 1, in accordance with some implementations, a technique 250 may be used for purposes of analyzing an archiving process in a given computer system. Pursuant to the technique 250, a partial snapshot of an archiving process is first captured (block 252) in a first computer system, such as the production system 10; and the partial snapshot is replicated (block 254) in a partition in a second computer system, such as the test system 200. This second computer system is used to evaluate the archiving process that is associated with the partial snapshot, pursuant to block 256.

Referring back to FIG. 1, among its other features, in accordance with some exemplary implementations, the server 20 may be a physical machine that contains hardware 50 and machine executable instructions that are executed by the hardware 50 for purposes of creating the instances of the above-described archive manager 40 and snapshot engine 42. As a non-limiting example, the hardware 50 may include one or multiple processors, such as one or multiple central processing units (CPUs) 52 and/or processing cores, depending on the particular implementation. In general, the processor executes machine executable instructions for purposes of creating the application(s) 64, archive manager 40, snapshot engine 42, user interface 43, etc. stored in a memory 54.

These instructions may, in general, be stored in the memory 54. The memory 54 is a non-transitory memory, such as a semiconductor memory, an optical storage memory, a magnetic storage memory, a local or remote memory, a removable media memory, etc., depending on the particular implementation. The particular hardware 50 mentioned herein is merely an example, as other architectures may be employed, in accordance with other implementations. It is noted that the hardware 50 may contain various other components such as a display, graphics controllers, etc., depending on the particular implementation. As shown in FIG. 1, the hardware 50 may also include, for example, a network interface card (NIC) 56, which communicates over a network with various entities, such as the clients 100, archive data databases 120, archive data databases 150, metadata databases 34, etc.

In addition to the applications 64, archive manager 40 and snapshot engine 42, the server 20 may include additional sets of machine executable instructions to create other components, such as an operating system 40, and one or multiple device drivers 66, which may be incorporated as part of the operating system 60, for example.

The snapshot engine 42 may present various options on the user interface 43 to govern the capturing of the snapshot. For example, in accordance with some implementations, the instance of the snapshot engine 42 causes the user interface 43 to display fields for the user to identify of one or more archiving environments for which a partial snapshot is to be taken; a target file or database to which the captured snapshot(s) are to be directed; access permissions to replicated snapshot environments; etc.

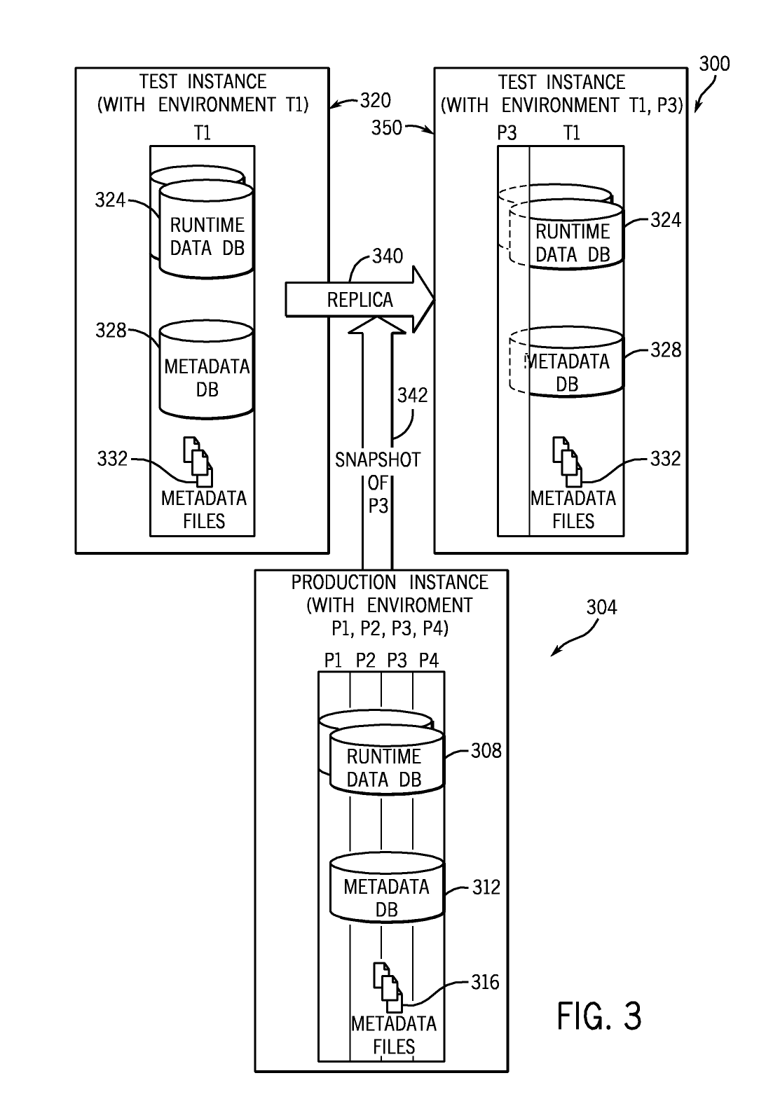

FIG. 3 depicts an illustration 300 of how the partial snapshot may be used to create a test instance for evaluating, improving, correcting and/or upgrading the archiving associated with the snapshot. In general, the test system 200 (see FIG. 1) has an associated test instance 320, with a preexisting corresponding test environment called “T1,” in FIG. 3. In general, the environment T1 contains a runtime data database 324, a metadata database 328 and possibly one or multiple metadata files 332. As described below, the test instance 320 is preserved, even though the snapshot is replicated onto the test system 200. In the corresponding production instance 304, for this example, the production instance 304 contains four environments called “P1,” “P2,” “P3,” and “P4.” Moreover, for this example, the partial snapshot is taken for the environment P3. As depicted in FIG. 3, in general, the production instance 304 contains one or multiple runtime data databases 308, a metadata database 312 and possibly one or multiple metadata files 316.

Due to the snapshot 342 of the environment P3, the snapshot 342 is added to a replica 340 of the test instance 320 to produce a new corresponding test instance 350. Comparing the test instances 350 and 320, the test instance 350 contains the environment T1 in addition to the environment P3, which was created from the snapshot 352. Thus, after the replication, the test instance 350 has the environment P3 from the production instance 304, which contains the same runtime states and configuration and also links to test data sources that may be replicated from the production instance 304. Therefore, running tasks in the P3 environment on the test instance 350 is the same as running the tasks in the production instance P3 at the time the snapshot was taken. Concurrently, the test instance's environment T1 is intact, and the customers can therefore continue developing and testing other projects relating to this environment.

As depicted in FIG. 3, each snapshot is a slice of the entire production system pertaining to the associated environment, including the metadata and the configuration data. Moreover, each snapshot is self-contained. Thus, the slices associated with the environments P1, P2, P3 and P4 combined constitute the entire system. This makes the replication solution composable.

Because customers may fix or update a relatively small part of the production system 10, replicating a relatively small number of environments may be sufficient to upgrade or perform corrective action for the system 10. Thus, the techniques and systems that are disclosed herein provide a more focused troubleshooting and testing solution.

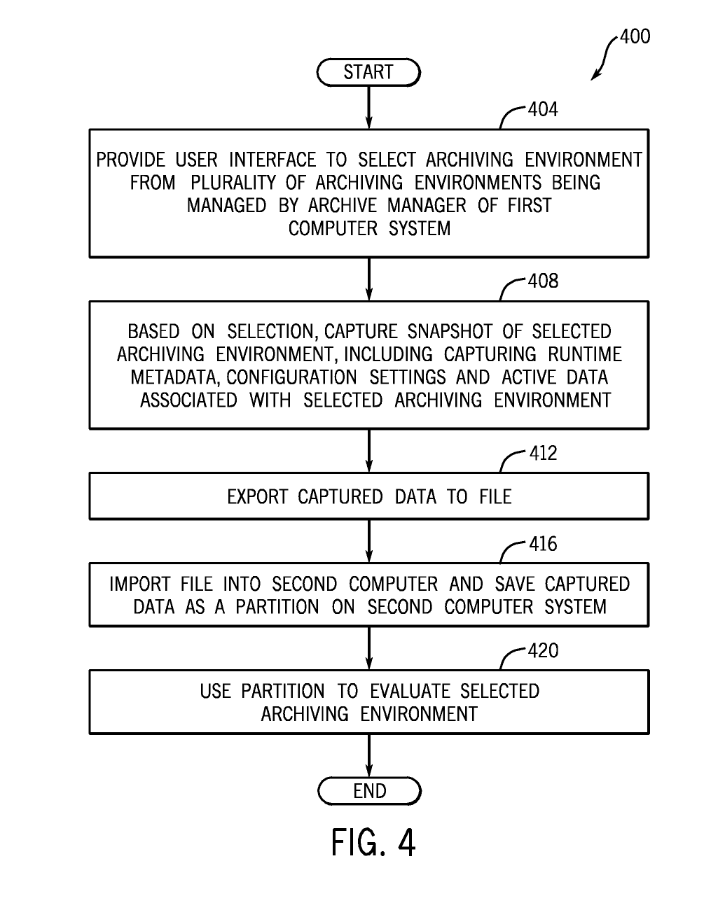

FIG. 4 depicts a technique 400 in accordance with example implementations. Pursuant to the technique 400, a user interface is provided (block 404) to select an archiving environment from a plurality of archiving environments that are managed by an archive manager of a first computer system, such as the production system 10. Based on this selection, the technique 400 includes capturing (block 408) a snapshot of the selected archiving environment, including capturing runtime metadata, configuration settings and active data associated with the selected archiving environment. Next, the technique 400 includes exporting (block 412) the captured data to a file; and importing the file into a second computer and saving the captured data as a partition on the second computer system, pursuant to block 416. The partition may then be used to evaluate the selected archiving environment, pursuant to block 420.

It is noted that the snapshot may be saved to a file system. Therefore, the capturing of the snapshot from the production system 100 and applying the snapshot to a test system 200 may occur in multiple steps at different times. In particular, users may export the snapshots and import them to test systems 200 at a significantly much later time. Moreover, the users may export once and import multiple times if the users want to refresh the test system 200 with the snapshot again. The same snapshot may also be imported to different systems. This makes it relatively convenient for developers to synchronize onsite engineers to a particular issue.

The above-described capturing of the snapshot from the production system 100 supports customization of how the snapshot is to be applied to the test system 200. These customizations may include, for example, links to various active sources, new environment names, access permissions, etc. Thus, for example, the access permissions may be changed for the snapshot when used in the test system 200, as compared to the access permissions that are used in the actual production system 10 for purposes of preserving secrecy of the permissions.

Thus, the systems and techniques that are disclosed herein allow the replication of production systems partially. The systems and techniques refresh test systems with snapshots taken from a production system so that the test system has the same runtime states and data usage. This approach facilitates relatively fast troubleshooting of a production system and provides an enhanced simulated test environment for future production system changes. The techniques and systems that are described herein further provide flexibility in replications of production systems. The snapshots from production systems can be applied to multiple systems, and the systems synchronize to a specific partition unit of the production system and maintain their original system states. The snapshots can be applied to use systems and customize ways.

The partial replication offers efficiency, as compared to a whole system replication. It saves time when a production system is relatively large and involves a relatively large amount of data. Moreover, the evaluation is relevant to the specific area that the customers are interested in and enables more focused troubleshooting and testing. Lastly, the systems and techniques that are disclosed herein offer enhanced administration management in that the administrators of the production system open the access to the archive manager 40 and the specific databases that are involved in a partial replication. Other and different advantages are contemplated and are within the scope of the appended claims.

While various embodiments have been described herein with respect to a limited number of embodiments, those skilled in the art, having the benefit of this disclosure, will appreciate numerous modifications and variations therefrom. It is intended that the appended claims cover all such modifications and variations.

What is claimed is:

1. A method comprising:
in a first computer system, archiving data for a plurality of environments, each of the environments being associated with a different combination of an active data source selected from a plurality of active data sources and an archive target selected from a plurality of archive targets; and
capturing a partial snapshot of the archiving, the partial snapshot being associated with one environment for the plurality of environments such that the partial snapshot may be used to replicate said archiving associated with the one environment on another computer system.

2. The method of claim 1, wherein the partial snapshot is constructed to be installed in a partition in said another computer system.

3. The method of claim 1, wherein the capturing comprises capturing metadata indicative of a runtime state of the archiving associated with said one environment.

4. The method of claim 1, wherein the capturing comprises capturing configuration settings for the archiving associated with said one environment.

5. The method of claim 1, wherein the capturing comprises capturing active data associated with the active data source for said one environment.

6. The method of claim 1, further comprising:
creating a test environment in a partition of said another computer system to evaluate said archiving associated with the one environment.

7. The method of claim 6, further comprising:
creating another test environment in another partition of said another computer system to evaluate archiving associated with another environment of said plurality of environments.

8. The method of claim 1, further comprising:
one said another computer system. selectively linking to the active data source and the archive target source associated with the environment.

9. The method of claim 1, further comprising:
one said another computer system, selectively assigning new access permissions to data associated with the partial snapshot.

10. An article comprising a storage medium to store instructions that when executed by at least one processor cause said at least one processor to:
provide a user interface to select an archiving environment from a plurality of archiving environments being managed by a processor-based archive manager, each of the environments being associated with a different combination of an active data source selected from a plurality of active data sources and an archive target selected from a plurality of archive targets; and
capture a snapshot of the selected archiving environment such that the snapshot may be used to replicate said archiving associated with the one environment on another computer system.

11. The article of claim 10, wherein the archiving uses a plurality of sets of metadata, each metadata set being partitioned in the first computer system based on the association of the metadata set with one of the environments.

12. The article of claim 10, wherein the archiving uses a plurality of sets of active data, each active data set being partitioned in the first computer system based on the association of the active data set with one of the environments.

13. The article of claim 10, wherein, for each environment, the archive manager is configured by an associated set of configuration data, each configuration data set being partitioned in the first computer system based on the association of the active data set with one of the environments.

14. The article of claim 10, further comprising:
saving a captured partial snapshot file to be imported to said another computer system.

15. A system comprising:
a processor-based archive manager to archive data for a plurality of environments, each of the environments being associated with a different combination of an active data source selected from a plurality of active data sources and an archive target selected from a plurality of archive targets; and
a processor-based snapshot engine to capture a partial snapshot of the archiving, the partial snapshot being associated with one environment for the plurality of environments such that the partial snapshot may be used to replicate said archiving associated with the one environment on another computer system.

16. The system of claim 15, wherein the archive manager is adapted to archive the data based on business flows and models that define rules for selecting data to be archived.

17. The system of claim 15, wherein the active data sources comprise online transaction processing databases.

18. The system of claim 15, wherein the partial snapshot is constructed to be installed in a partition in said another computer system.

19. The system of claim 15, wherein the capturing comprises capturing metadata indicative of a runtime state of the archiving associated with said one environment.

20. The system of claim 15, wherein the capturing comprises capturing configuration settings for the archiving associated with said one environment.
